(19) United States
(12) Patent Application Publication
(10) Pub. No.: US 2008/0271728 A1
(43) Pub. Date: Nov. 6, 2008

(54) GRILLER WITH DETACHABLE STOVE

(76) Inventor: Lucas PAI, Taichung City (TW)

Correspondence Address: EGBERT LAW OFFICES, 412 MAIN STREET, 7TH FLOOR, HOUSTON, TX, 77002, US

(21) Appl. No.: 11/744,448

(22) Filed: May 4, 2007

(51) Int. Cl. A47J 37/07

(52) U.S. Cl. 126/25 R

(57) ABSTRACT

The present invention provides a griller with detachable stove. The griller includes a pedestal portion and a stove portion. The stove has a connecting portion at a bottom of the main body of the stove, that can be assembled onto the stove coupling portion of the pedestal portion. Thus, the stove is integrated with the pedestal, or the stove can be removed from the pedestal for independent use. In such a case, the stove can be placed on the ground or a desk via the stand at the bottom of the main body. The large-sized griller of the present invention can be converted into a lightweight type of griller.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a griller, and more particularly to an innovative griller which permits the stove portion of the griller to be separated easily from the pedestal portion of the griller.

2. Description of Related Art Including Information Disclosed Under 37 CFR 1.97 and 37 CFR 1.98.

The griller is a commonly used product in today's outdoor leisure activities. In the present market, the griller is generally categorized into ground-based, desk-type, or free-standing types (hereinafter referred to as a large-sized griller), depending upon different user requirements.

Many users are often prone to purchase large-sized grillers, however, this type of grillers is not suitable for outdoor leisure activities at various locations, such as sloped ground and river beds. For this reason, the users must purchase additional lightweight grillers, leading to higher costs and greater storage demands on the user.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The stove portion of the present invention includes a connecting portion at a bottom of the main body of the stove portion. The connecting portion can be assembled onto the stove coupling portion of the pedestal portion of the griller. Thus, the stove portion is integrated with the pedestal portion, as a combination style griller. Alternatively, the stove portion can be removed from the pedestal portion for separate use. In such a case, the stove portion can be placed on the ground or desk via the stand at the bottom of the main body. Based on this innovation, the large-sized griller can be converted into a lightweight ground-based or desk-type of griller to cater to various user demands.

Based on the structures of the present invention, the auxiliary table at both sides of the main body of stove portion can be rotatable. The auxiliary tables are retracted by rotating towards the interior of main body, thus reducing the volume of the stove portion and meeting space-saving requirements.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the griller of the present invention.

FIG. 2 shows an exploded perspective view of the griller of the present invention.

FIG. 3 shows a partial sectional view of the griller of the present invention.

FIG. 4 shows a perspective view of the operation of the stove portion in independent use.

FIG. 5 shows an assembled perspective view of the stand of the stove portion of the present invention.

FIG. 6 shows an exploded perspective view of the stand of the present invention.

FIG. 7 shows a front view of the auxiliary table of the present invention, which rotates towards the interior of the main body.

FIG. 8 shows another front view and partial sectional view of the operation of the auxiliary table of the present invention, the auxiliary table being retracted into the main body.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

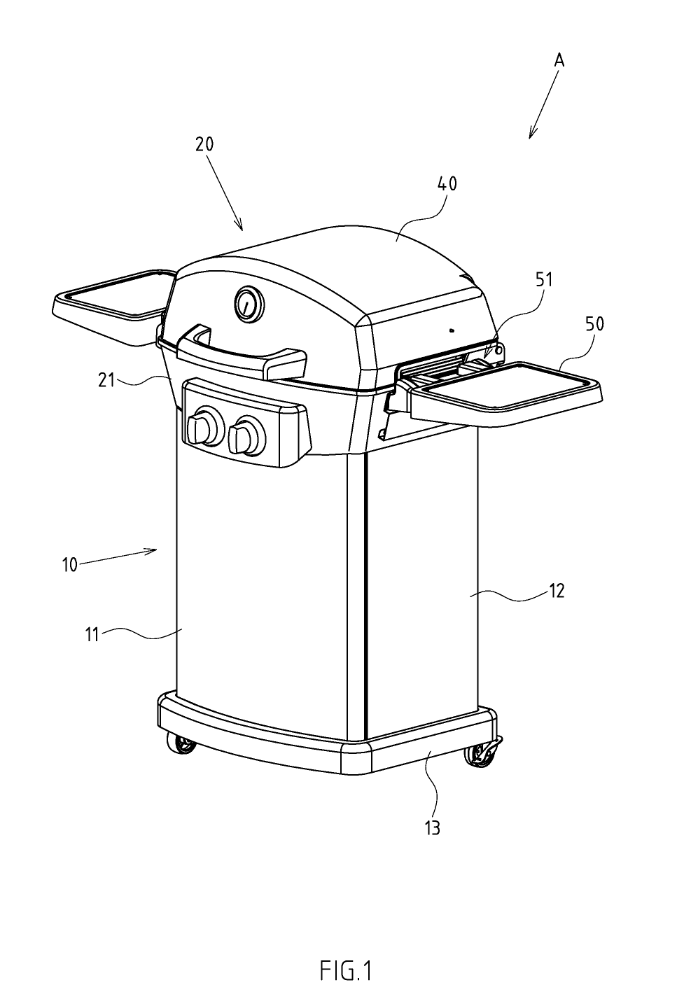

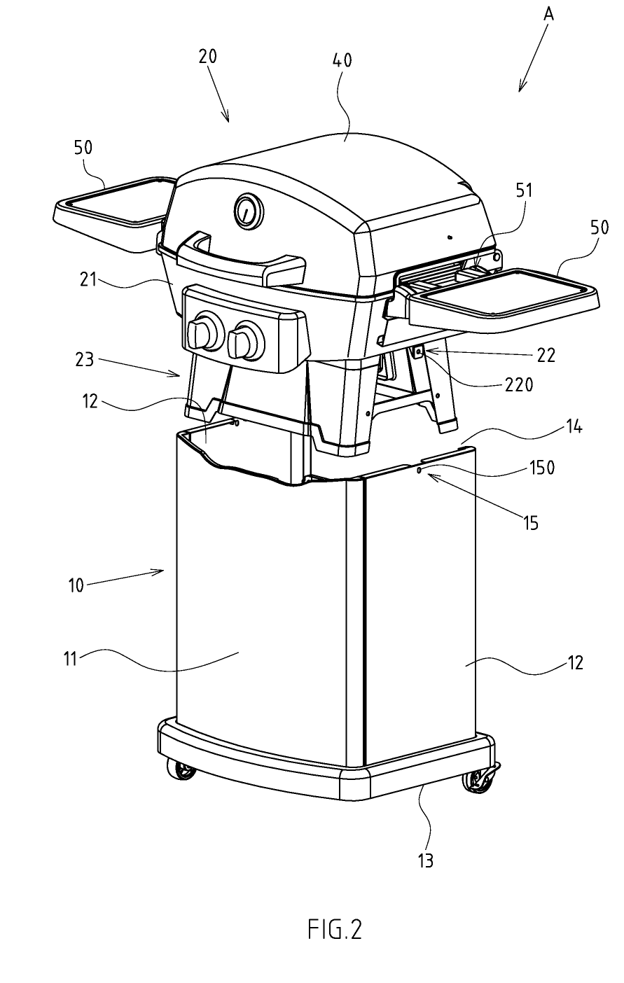

FIGS. 1 and 2 depict preferred embodiments of improved griller of the present invention. The preferred embodiment is provided only for explanatory purposes.

The griller A includes a pedestal portion 10, which is composed of predefined plates and/or rods. In a preferred embodiment, the pedestal portion 10 contains a front board 11 and left, right boards 12, forming an enclosed space. The pedestal portion 10 is defined to form a locating end 13 and a top end 14, where a stove coupling portion 15 is provided.

The griller A also includes a stove portion 20, which has a main body 21. The main body 21 has a connecting portion 22 at a bottom thereof, that can be assembled onto the stove coupling portion 15 of the pedestal portion 10. Thus, the stove 20 portion can be integrated with the pedestal portion 10. A stand 23 is placed at the bottom of the main body 21.

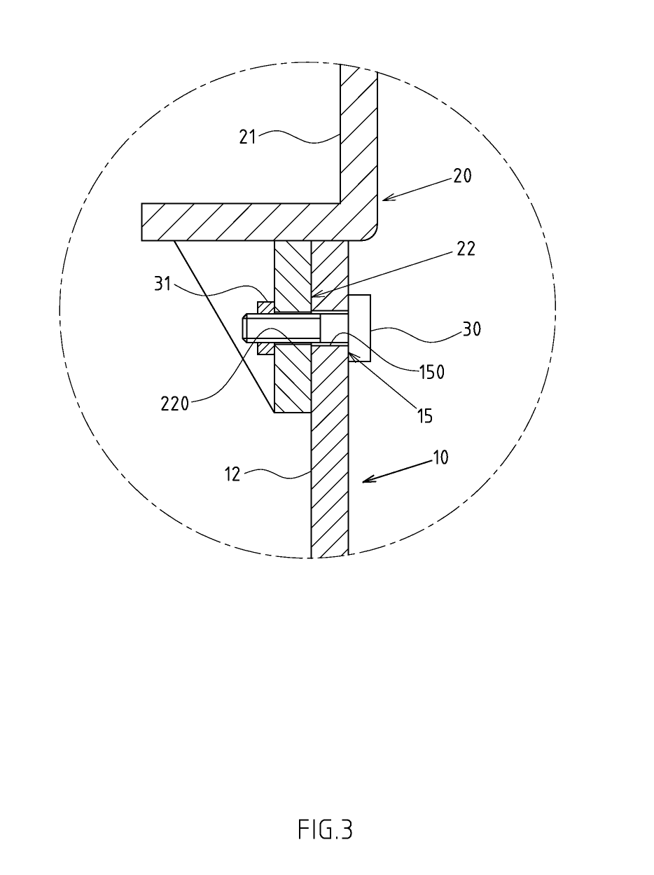

FIG. 3 depicts a preferred embodiment of the connecting portion 22 at the bottom of main body 21 of the stove portion 20 and the stove coupling portion 15 of the pedestal portion 10. Through-holes 220, 150 are placed in alignment. Then, the through holes 220, 150 are screwed tightly therethrough by bolt 30 and affixed in place by nut 31.

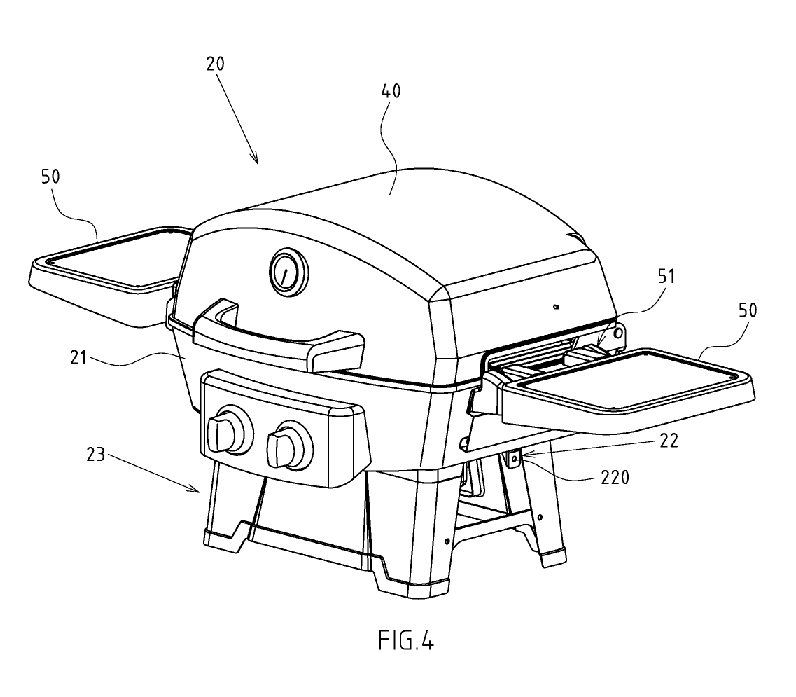

As shown in FIG. 4, the stove portion 20 can be removed from the pedestal portion 10 for separate use. In such a case, the stove portion 20 can be placed on the ground or desk via the stand 23 at the bottom of the main body 21.

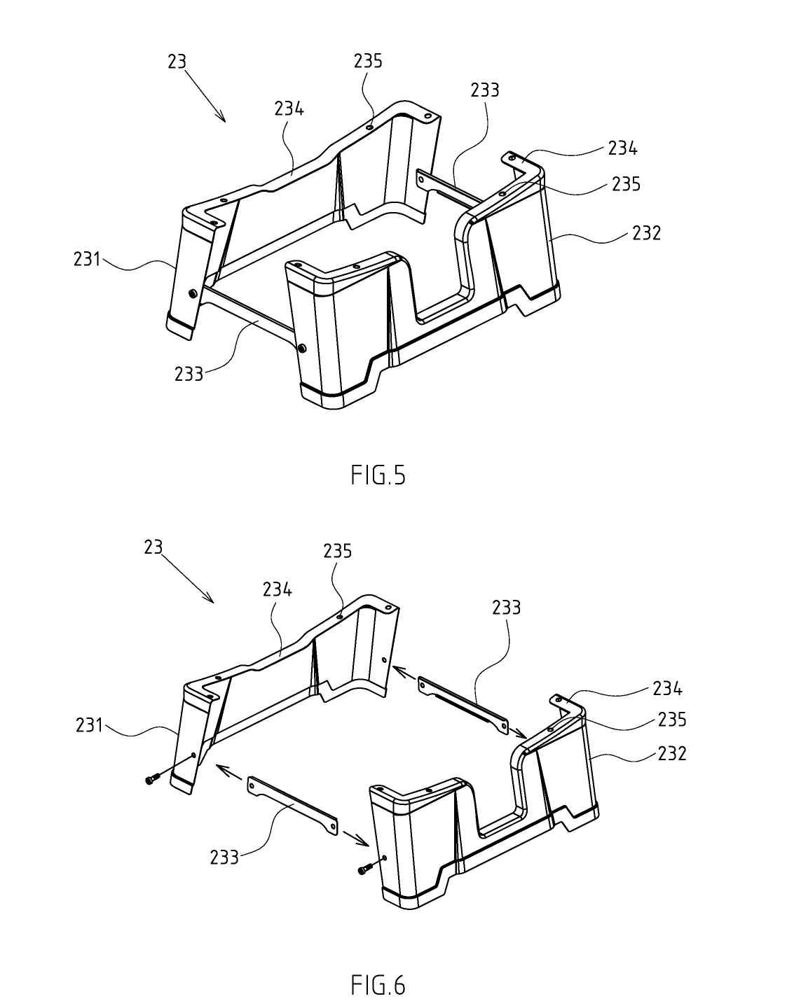

FIGS. 5 and 6 depict a preferred embodiment of stand 23 as adapted to the bottom of the main body 21 of the stove portion 20. The stand 23 is composed of vertically arranged first and second boards 231, 232, and a connecting rack 233 horizontally arranged between the first and second boards 231, 232. At the top of the first and second boards 231, 232, a transverse flange 234 is formed. The transverse flange is provided with several mounting holes 235, allowing positioning at the bottom of main body 21 of the stove portion 20, as shown in FIG. 4. The stand may also be applied to a small-sized griller structure, e.g. a collapsible metal foot rest, a flexible support and cushion block, all of which can be implemented using existing technologies.

A movable cover 40 is arranged onto the top of main body of the stove portion 20, thus enabling the baking and cooking behavior.

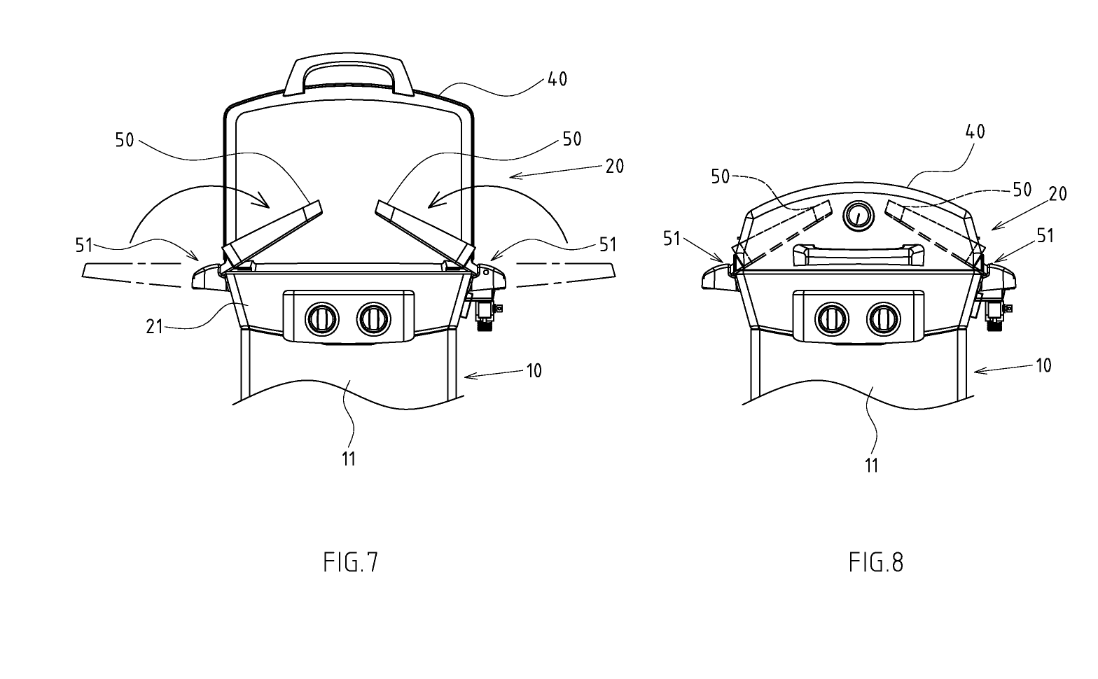

As shown in FIGS. 1 and 4, two auxiliary tables 50 are laterally placed at both sides of main body 21 of the stove portion 20. So, this auxiliary table 50 increases storage area of the stove portion 20. Additionally, the auxiliary table 50 can be rotatable, for example, the auxiliary table 50 of the present invention and the main body 21 are linked by a movable joint 51. Referring to FIGS. 7, 8, the auxiliary tables 50 at both sides could be retracted by rotating the tables 50 towards the interior of main body 21, thus reducing the volume of the stove portion 20 to meet space-saving requirements.

Based upon the above-specified structures of the stove portion 20, the griller of the present invention has two states: a large-sized griller combining the stove portion 20 and pedestal portion 10, as shown in FIG. 1; or a lightweight griller, enabling independent use of stove portion 20 without the pedestal portion, as shown in FIG. 2.

1. A griller structure, comprising:
a pedestal portion, being comprised of predefined plates and rods and having a locating end and a top end, said top end having a stove coupling portion mounted thereon; and
a stove portion, being comprised of a main body, a connecting portion at a bottom thereof and removably engaged to said stove coupling portion of said pedestal portion, and a stand placed at the bottom of the main body.

2. The griller structure defined in claim 1, wherein said connecting portion has a plurality of through-holes and said stove coupling portion has a plurality of through-holes, said through-holes of said connecting portion being aligned with said through-holes of said stove coupling portion and being removably attached by nut and bolt assemblies.

3. The griller structure defined in claim 1, wherein said stand is comprised of vertically arranged first and second boards, and a connecting rack horizontally arranged between the first and second boards.

4. The griller structure defined in claim 1, wherein said stove portion is removed from said pedestal portion for independent use, the botto thereof being placed on ground or desk via said stand.

5. The griller structure defined in claim 1, wherein said main body has a top end with a movable cover.

6. The griller structure defined in claim 1, wherein said main body has two auxiliary tables laterally placed at both sides of said main body.

7. The griller structure defined in claim 6, wherein the auxiliary tables are rotatable, the auxiliary tables being retracted by rotation towards an interior of said main body.
